(19) United States
(12) Patent Application Publication
(10) Pub. No.: US 2026/0155389 A1
(43) Pub. Date: Jun. 4, 2026

(54) NEGATIVE ELECTRODE PLATE, SECONDARY BATTERY, AND ELECTRONIC DEVICE

(71) Applicant: Ningde Amperex Technology Limited, Ningde, Fujian (CN)

(72) Inventors: Ao LIU, Ningde, Fujian (CN); Ruitao WU, Ningde, Fujian (CN)

(73) Assignee: Ningde Amperex Technology Limited, Ningde, Fujian (CN)

(21) Appl. No.: 19/090,466

(22) Filed: Mar. 26, 2025

(30) Foreign Application Priority Data
Mar. 28, 2024 (CN) 202410363122.0

(51) Int. Cl. H01M 4/66; H01M 4/02; H01M 10/0525

(52) U.S. Cl. CPC H01M 4/667; H01M 4/663; H01M 4/668; H01M 10/0525; H01M 2004/021; H01M 2004/027

(57) ABSTRACT

A negative electrode plate includes a negative current collector, the negative current collector includes a substrate layer and a conductive coating disposed on a surface of the substrate layer. The conductive coating includes a conductive agent and a binder. A material of the substrate layer includes at least one selected from the group consisting of polypropylene, polyethylene, polyethylene terephthalate, cellulose, polyimide, polyamide, spandex, and aramid. A porosity of the substrate layer is 10% to 50%. Tensile strength of the substrate layer is 130 MPa to 200 MPa. The negative current collector includes the substrate layer and the conductive coating, and the porosity and the tensile strength of the substrate layer are controlled within the above ranges, thereby improving the safety, reliability, and C-rate performance of the secondary battery.

### CROSS-REFERENCE TO THE RELATED APPLICATION

The present application claims priority to Chinese Patent Application No. 202410363122.0, filed on Mar. 28, 2024, the disclosure of which is hereby incorporated by reference in its entirety.

### TECHNICAL FIELD

This application relates to the field of electrochemical technology, and in particular, to a negative current collector, a negative electrode plate, a secondary battery, and an electronic device.

### BACKGROUND

By virtue of a high energy storage density, a high open-circuit voltage, a low self-discharge rate, a long cycle life, high safety, and other merits, secondary batteries such as lithium-ion batteries are widely used in various fields such as portable electrical energy storage, electronic devices, and electric vehicles.

Currently, negative electrode plates of most of pouch lithium-ion batteries on the market employ a copper current collector, and the cost of copper foil is relatively high. In addition, the relatively large mass of the copper current collector makes the overall mass of a lithium-ion battery relatively large. In a process of an accidental drop or collision of a secondary battery, the risk of contact and short circuiting between a positive current collector and a negative current collector is greatly increased, thereby impairing the safety and reliability of the lithium-ion battery.

### SUMMARY

An objective of this application is to provide a negative current collector, a negative electrode plate, a secondary battery, and an electronic device to reduce the cost of the secondary battery while improving the safety and reliability of the secondary battery. Specific technical solutions are as follows:

A first aspect of this application provides a negative current collector. The negative current collector includes a substrate layer and a conductive coating disposed on a surface of the substrate layer. The conductive coating includes a conductive agent and a binder. The material of the substrate layer includes at least one selected from the group consisting of polypropylene, polyethylene, polyethylene terephthalate, cellulose, polyimide, polyamide, spandex, and aramid. The porosity of the substrate layer is 10% to 50%. Tensile strength of the substrate layer is 130 MPa to 200 MPa. The negative current collector includes the substrate layer and the conductive coating, and the porosity and tensile strength of the substrate layer are controlled within the above ranges, thereby reducing the mass of the negative current collector while making the resistance of the negative current collector relatively low, making the secondary battery lightweight, and reducing the cost of the secondary battery. In addition, in contrast to copper foil as a negative current collector, the contact resistance of the negative current collector of this application in contact with the positive current collector to cause a short circuit is relatively high, thereby reducing the risk of internal short-circuiting of the secondary battery, and in turn, improving the safety and reliability of the secondary battery. Moreover, because the substrate layer is of a relatively high porosity, applying the negative current collector to the negative electrode plate makes it convenient for an electrolyte solution to infiltrate the negative electrode plate, and increases the transmission channels of lithium ions, thereby improving the C-rate performance of the secondary battery.

In some embodiments of this application, the thickness of the substrate layer is 5 μm to 20 μm. By controlling the thickness of the substrate layer within the above range, this application endows the substrate layer with good mechanical properties, improves the safety and reliability of the secondary battery, and at the same time, endows the secondary battery with a relatively high energy density.

In some embodiments of this application, the porosity of the substrate layer is 30% to 50%, and tensile strength of the substrate layer is 150 MPa to 200 MPa. The porosity and tensile strength of the substrate layer are controlled within the above ranges, thereby more favorably improving the safety, reliability, and C-rate performance of the secondary battery.

In some embodiments of this application, the conductive agent includes at least one selected from the group consisting of conductive graphite, conductive carbon black, carbon nanotubes, graphene, and carbon fibers. Based on the mass of the conductive coating, the mass percentage of the conductive agent is 5% to 95%. Selecting the above conductive agent and controlling the mass percentage of the conductive agent within the above range are conducive to constructing a conductive network on the surface of the substrate layer, make the resistance of the negative current collector relatively low, and make the secondary battery lightweight while improving the safety and reliability of the secondary battery.

In some embodiments of this application, based on the mass of the conductive layer, the mass percentage of the conductive agent is 30% to 50%. By adjusting the mass percentage of the conductive agent within the above range, this application enables even a relatively low content of the conductive coating to construct a conductive network on the surface of the substrate layer, thereby making the secondary battery lightweight while improving the safety and reliability of the secondary battery.

In some embodiments of this application, the thickness of the conductive coating is 0.2 μm to 5 μm. By controlling the thickness of the conductive coating within the above range, this application makes the resistance of the negative electrode plate relatively low, makes the secondary battery lightweight, and improves the safety and reliability of the secondary battery while endowing the secondary battery with a relatively high energy density.

In some embodiments of this application, the thickness of the conductive coating is 0.5 μm to 2 μm. By adjusting the thickness of the conductive coating within the above range, this application more favorably improves the safety and reliability of the secondary battery while endowing the secondary battery with a relatively high energy density.

A second aspect of this application provides a negative electrode plate. The negative electrode plate includes the negative current collector according to the first aspect of this application. The negative current collector of this application is light in weight and low in cost, thereby reducing the mass of the negative electrode plate, making the secondary battery lightweight, and reducing the cost of the secondary battery. In addition, in contrast to copper foil as a negative current collector, the contact resistance of the negative current collector of this application in contact with the positive current collector to a cause a short circuit is relatively high, thereby reducing the risk of internal short-circuiting of the secondary battery, and in turn, improving the safety and reliability of the secondary battery. Moreover, because the substrate layer is of a relatively high porosity, applying the negative current collector of this application to the negative electrode plate makes it convenient for the electrolyte solution to infiltrate the negative electrode plate, thereby improving the C-rate performance of the secondary battery.

A third aspect of this application provides a secondary battery. The secondary battery includes a negative tab and the negative electrode plate according to the second aspect of this application. The negative electrode plate and the negative tab are assembled together by a riveting technique. The negative tab runs through the negative electrode plate along the thickness direction of the negative electrode plate. The negative tab is connected to the conductive coating to form an electrical connection. The negative current collector of this application is relatively lightweight and of a relatively low resistance. The negative tab and the negative current collector can be combined by a riveting technique so as to form an electronic connection channel, thereby making the secondary battery lighter and thinner while improving the safety and reliability of the secondary battery and reducing the cost of the secondary battery.

A fourth aspect of this application provides an electronic device. The electronic device includes the secondary battery according to the third aspect of this application. The secondary battery provided in this application is of high safety and reliability, and therefore, the electronic device of this application achieves a relatively long service life.

Some of the beneficial effects of this application are as follows:

This application provides a negative current collector, a negative electrode plate, a secondary battery, and an electronic device. The negative current collector includes a substrate layer and a conductive coating disposed on a surface of the substrate layer. The conductive coating includes a conductive agent and a binder. A material of the substrate layer includes at least one selected from the group consisting of polypropylene, polyethylene, polyethylene terephthalate, cellulose, polyimide, polyamide, spandex, and aramid. A porosity of the substrate layer is 10% to 50%. Tensile strength of the substrate layer is 130 MPa to 200 MPa. The negative current collector includes the substrate layer and the conductive coating, and the porosity and tensile strength of the substrate layer are controlled within the above ranges, thereby reducing the mass of the negative current collector while making the resistance of the negative current collector relatively low, making the secondary battery lightweight, and reducing the cost of the secondary battery. In addition, in contrast to copper foil as a negative current collector, the contact resistance of the negative current collector of this application in contact with the positive current collector to a cause a short circuit is relatively high, thereby reducing the risk of internal short-circuiting of the secondary battery, and in turn, improving the safety and reliability of the secondary battery. Moreover, because the substrate layer is of a relatively high porosity, applying the negative current collector to the negative electrode plate makes it convenient for the electrolyte solution to infiltrate and diffuse in the negative electrode plate, and increases the transmission channels of lithium ions, thereby improving the C-rate performance of the secondary battery.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a schematic structural diagram of a negative current collector according to an embodiment of this application; and

FIG. 2 is a schematic structural diagram of a negative current collector according to another embodiment of this application.

List of reference numerals: negative current collector 10, substrate layer 11, conductive coating 12, first conductive coating 121, second conductive coating 122.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

It is hereby noted that in the following description, this application is construed by using a lithium-ion battery as an example of the secondary battery, but the secondary battery of this application is not limited to the lithium-ion battery. Specific technical solutions are as follows:

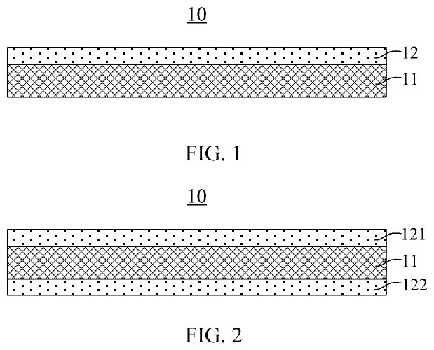

A first aspect of this application provides a negative current collector. The negative current collector includes a substrate layer and a conductive coating disposed on the surface of the substrate layer. In this application, the conductive coating is disposed on at least one surface of the substrate layer along the thickness direction. In other words, the conductive coating may be disposed on one surface of the substrate layer along the thickness direction, as shown in FIG. 1. The negative current collector 10 includes a substrate layer 11 and a conductive coating 12 disposed on one surface of the substrate layer 11. Alternatively, the conductive coating may be disposed on two surfaces of the substrate layer along the thickness direction, as shown in FIG. 2, and the negative current collector 10 includes a substrate layer 11 as well as a first conductive coating 121 and a second conductive coating 122 disposed on two surfaces of the substrate layer 11 respectively. The conductive coating includes a conductive agent and a binder. The material of the substrate layer includes at least one of polypropylene (PP), polyethylene (PE), polyethylene terephthalate (PET), cellulose, polyimide (PI), polyamide, spandex, or aramid. The porosity of the substrate layer is 10% to 50%, and preferably 30% to 50%. The tensile strength of the substrate layer is 130 MPa to 200 MPa, and preferably 150 MPa to 200 MPa. For example, the porosity of the substrate layer may be 10%, 15%, 20%, 23%, 25%, 28%, 30%, 33%, 36%, 40%, 44%, 50%, or a value falling within a range formed by any two thereof, and the tensile strength of the substrate layer may be 130 MPa, 140 MPa, 146 MPa, 150 MPa, 158 MPa, 160 MPa, 164 MPa, 170 MPa, 175 MPa, 180 MPa, 190 MPa, 200 MPa, or a value falling within a range formed by any two thereof.

The applicant hereof finds that the negative current collector includes the substrate layer and the conductive coating, and the porosity and tensile strength of the substrate layer are controlled within the above ranges, thereby reducing the mass of the negative current collector while making the resistance of the negative current collector relatively low, making the secondary battery lightweight, and reducing the cost of the secondary battery. In addition, in contrast to copper foil as a negative current collector, the contact resistance of the negative current collector of this application in contact with the positive current collector to cause a short circuit is relatively high, thereby reducing the risk of internal short-circuiting of the secondary battery, and in turn, improving the safety and reliability of the secondary battery. Moreover, because the substrate layer is of a relatively high porosity, applying the negative current collector to the negative electrode plate makes it convenient for the electrolyte solution to infiltrate the negative electrode plate, thereby improving the C-rate performance of the secondary battery. When the porosity of the substrate layer is excessively low, for example, lower than 10%, the number of lithium-ion transmission channels is relatively small, thereby being adverse to lithium ion transmission, and resulting in a decline in the C-rate performance of the secondary battery. When the porosity of the substrate layer is excessively high, for example, higher than 50%, the requirement on the material performance of the substrate layer is excessively high, and the material of the substrate layer is hardly available and is costly. When the tensile strength of the substrate layer is excessively small, for example, less than 130 MPa, the mechanical properties of the substrate layer are not enough to support a negative electrode material layer and are prone to deform. When the tensile strength of the substrate layer is excessively large, for example, greater than 200 MPa, the requirement on the material performance of the substrate layer is excessively high, and the substrate layer is costly. Therefore, the porosity and tensile strength of the substrate layer are controlled within the ranges specified herein, thereby reducing the cost of the secondary battery and improving the safety and reliability of the secondary battery, and also improving the C-rate performance of the secondary battery.

In this application, the substrate layer is a thin film of the above polymer, and is commercially available and can be tested with reference to the test method of “Porosity test and substrate-layer tensile strength test” provided herein. The thin film with the desired porosity and tensile strength is selected as the substrate layer. The method for preparing the substrate layer is not particularly limited herein as long as the objectives of this application can be achieved. For example, the substrate layer may be obtained by the following preparation method: mixing colloidal particles of the material of the substrate layer, a pore-forming agent, and an additive, and then heating the mixture to melt, and performing processes such as extrusion, tape-casting, transverse stretching, cooling, and molding to obtain a substrate layer film. The mass ratio between the colloidal particles, the pore-forming agent, and the additive are not particularly limited herein, and may be adjusted as actually required, as long as the objectives of this application can be achieved. The weight-average molecular weight (Mw) of the material of the substrate layer is not particularly limited herein, as long as the objectives of this application can be achieved. For example, the weight-average molecular weight may be 300,000 to 600,000. The type of the pore-forming agent is not particularly limited herein, and may be selected as actually required as long as the objectives of this application can be achieved. For example, the pore-forming agent may be white oil. In this application, the additive may include, but is not limited to, a coupling agent, an antioxidant, and the like. The type of the additive is not particularly limited herein, and may be selected as actually required as long as the objectives of this application can be achieved. The device used in the extrusion process is not particularly limited herein, and may be selected as actually required as long as the objectives of this application can be achieved. For example, a twin-screw extruder may be used for the extrusion process. In this application, the term “transverse stretching” refers to stretching in a direction perpendicular to the extrusion direction.

Generally, the tensile strength of the substrate layer may be changed by changing the weight-average molecular weight and the crosslinking degree of the material of the substrate material. When other conditions remain constant, with the increase of the weight-average molecular weight, the tensile strength of the substrate layer increases; with the decrease of the weight-average molecular weight, the tensile strength of the substrate layer decreases. With the increase of the crosslinking degree, the tensile strength of the substrate layer increases; with the decrease of the crosslinking degree, the tensile strength of the substrate layer decreases. The porosity of the substrate layer can be changed by changing the content of the pore-forming agent. When other conditions remain constant, increasing the content of the pore-forming agent increases the porosity of the substrate layer, and decreasing the content of the pore-forming agent reduces the porosity of the substrate layer. The porosity of the substrate layer can also be changed by changing the conditions of transverse stretching. Increasing the stretch rate increases the porosity of the substrate layer, and decreasing the stretch rate reduces the porosity of the substrate layer. “Stretch rate” refers to a ratio of a transverse dimension of a stretched film to a transverse dimension of the film before stretching. It is understandable to a person skilled in the art that when other conditions remain constant, increasing the amount of the pore-forming agent and increasing at least one of the weight-average molecular weight or crosslinking degree of the material of the substrate layer at the same time can increase the porosity of the substrate layer while keeping the tensile strength unchanged. In other words, the substrate layers of different porosities and the same tensile strength as well as the substrate layers of the same porosity and different tensile strengths can be obtained by adjusting a plurality of parameters simultaneously, the details of which are omitted here.

In some embodiments of this application, the thickness of the substrate layer is 5 μm to 20 μm. For example, the thickness of the substrate layer may be 5 μm, 6 μm, 8 μm, 12 μm, 14 μm, 15 μm, 16 μm, 17 μm, 19 μm, 20 μm, or a value falling within a range formed by any two thereof. By controlling the thickness of the substrate layer within the above range, this application endows the substrate layer with good mechanical properties, exerts the supporting role of the substrate layer, improves the safety and reliability of the secondary battery, and at the same time, endows the secondary battery with a relatively high energy density.

In some embodiments of this application, the conductive agent includes at least one of conductive graphite, conductive carbon black (SP), carbon nanotubes (CNT), graphene, or carbon fibers (VCF), and preferably, carbon nanotubes. Based on the mass of the conductive coating, the mass percentage of the conductive agent is 5% to 95%, and preferably, 30% to 50%. For example, the mass percentage of the conductive agent may be 5%, 10%, 14%, 20%, 23%, 25%, 30%, 34%, 35%, 38%, 40%, 43%, 45%, 48%, 50%, 60%, 70%, 80%, 90%, 95%, or a value falling within a range formed by any two thereof. Selecting the above conductive agent and controlling the mass percentage of the conductive agent within the above range are conducive to constructing a conductive network of relatively high conductivity on the surface of the substrate layer, make the resistance of the negative current collector relatively low, and make the secondary battery lightweight while improving the safety, reliability, and C-rate performance of the secondary battery.

In this application, the type of the binder in the conductive coating is not particularly limited as long as the objectives of this application can be achieved. For example, the binder may include, but is not limited to, at least one of polyvinylidene fluoride, poly(vinylidene fluoride-co-hexafluoropropylene), polyamide, polyacrylonitrile, polymethyl acrylate, polyethyl acrylate, polybutyl acrylate, polyacrylic acid, polyacrylate salt, sodium carboxymethyl cellulose, polyvinylpyrrolidone, polyvinyl ether, polymethyl methacrylate, polytetrafluoroethylene, or polyhexafluoropropylene. The mass percentage of the binder is not particularly limited herein. For example, based on the mass of the conductive coating, the mass percentage of the binder may be 5% to 95%.

In some embodiments of this application, the thickness of the conductive coating is 0.2 μm to 5 μm, and preferably, 0.5 μm to 2 μm. For example, the thickness of the conductive coating is 0.2 μm, 0.5 μm, 0.8 μm, 1 μm, 1.5 μm, 2 μm, 3 μm, 4 μm, 5 μm, or a value falling within a range formed by any two thereof. By controlling the thickness of the conductive coating within the above range, this application makes the resistance of the negative electrode plate relatively low, makes the secondary battery lightweight, and improves the safety and reliability of the secondary battery while endowing the secondary battery with a relatively high energy density.

The method for preparing the negative current collector is not particularly limited herein as long as the objectives of this application can be achieved. For example, the negative current collector may be prepared by the following method: mixing the conductive agent and the binder, adding deionized water, and stirring well to obtain a conductive coating slurry in which the solid content is 20 wt % to 50 wt %; applying the conductive coating slurry evenly on one surface of the substrate layer, and oven-drying the slurry to obtain a negative current collector coated with a conductive coating on a single side. The above coating steps are repeated on the other surface of the substrate layer, and the slurry is oven-dried to obtain a negative electrode plate coated with a conductive coating on both sides.

A second aspect of this application provides a negative electrode plate. The negative electrode plate includes the negative current collector according to the first aspect of this application. The negative current collector of this application is light in weight and low in cost, thereby reducing the mass of the negative electrode plate, making the secondary battery lightweight, and reducing the cost of the secondary battery. In addition, in contrast to copper foil as a negative current collector, the contact resistance of the negative current collector of this application in contact with the positive current collector to a cause a short circuit is relatively high, thereby reducing the risk of internal short-circuiting of the secondary battery, and in turn, improving the safety and reliability of the secondary battery. Moreover, because the substrate layer is of a relatively high porosity, applying the negative current collector of this application to the negative electrode plate makes it convenient for the electrolyte solution to infiltrate the negative electrode plate, thereby improving the C-rate performance of the secondary battery.

In this application, the negative electrode plate is not particularly limited, as long as the objectives of this application can be achieved. For example, the negative electrode plate includes a negative current collector and a negative electrode material layer disposed on at least one surface of the negative current collector. In this application, the negative electrode material layer may be disposed on one surface of the negative current collector in the thickness direction of the negative current collector. In this case, the conductive coating just needs to be applied to one surface of the substrate layer of the negative current collector, and the negative electrode material layer is disposed on the surface of the conductive coating. Alternatively, the negative electrode material layer may be disposed on both surfaces of the negative current collector in the thickness direction of the negative current collector. In this case, accordingly, the conductive coating are applied to both surfaces of the substrate layer of the negative current collector. It is hereby noted that the “surface” here may be the entire region of the negative current collector, or a partial region of the negative current collector, without being particularly limited herein, as long as the objectives of the application can be achieved. The negative electrode material layer in this application includes a negative active material. The type of the negative active material is not particularly limited in this application, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ (0<x≤2), Li—Sn alloy, Li—Sn—O alloy, Sn, SnO, SnO₂, spinel-structured lithium titanium oxide Li₄Ti₅O₁₂, Li—Al alloy, or metallic lithium. The thickness of the negative electrode material layer is not particularly limited herein, as long as the objectives of this application can be achieved. For example, the thickness of the negative electrode material layer is 30 μm to 160 μm. The mass ratio between the negative active material, the negative conductive agent, and the negative electrode binder in the negative electrode material layer is not particularly limited herein as long as the objectives of this application can be achieved.

The negative electrode material layer of this application may further include a negative conductive agent, a negative electrode binder, and a negative electrode dispersant. The negative conductive agent and the negative electrode binder are not particularly limited herein, as long as the objectives of this application can be achieved. For example, the negative electrode binder may include, but is not limited to, at least one of conductive carbon black, carbon nanotubes, graphite, carbon fibers, carbon nanowires, graphene, a metal material, or a conductive polymer. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The negative electrode dispersant may include sodium carboxymethyl cellulose.

The method for preparing the negative electrode plate is not particularly limited herein as long as the objectives of this application can be achieved. For example, the negative electrode plate may be prepared by the following method: mixing a negative active material, a negative conductive agent, a negative electrode binder, and a negative electrode dispersant, adding deionized water, and stirring well to obtain a negative electrode slurry in which the solid content is 50 wt % to 75 wt %; applying the negative electrode slurry evenly on one surface of the negative current collector, and oven-drying the slurry to obtain a negative electrode plate coated with a negative electrode material layer on a single side. Subsequently, the above coating steps are repeated on the other surface of the negative current collector, and the negative current collector is oven-dried to obtain a negative electrode plate coated with a negative electrode material layer on both sides. After completion of applying the slurry, a negative electrode plate is obtained by cold-pressing and cutting.

A third aspect of this application provides a secondary battery. The secondary battery includes a negative tab and the negative electrode plate according to the second aspect of this application. The negative electrode plate and the negative tab are assembled together by a riveting technique. The negative tab runs through the negative electrode plate along the thickness direction of the negative electrode plate. The negative tab is connected to the conductive coating to form an electrical connection. The negative current collector of this application is relatively lightweight and of a relatively low resistance. The negative tab and the negative current collector can be combined by a riveting technique so as to form an electronic connection channel, thereby making the secondary battery lighter and thinner while improving the safety and reliability of the secondary battery and reducing the cost of the secondary battery.

The thickness of the negative tab is not particularly limited herein as long as the objectives of this application can be achieved. For example, the thickness of the negative tab is 60 μm to 100 μm.

The secondary battery of this application further includes a positive electrode plate. In this application, the positive electrode plate is not particularly limited, as long as the objectives of this application can be achieved. For example, the positive electrode plate includes a positive current collector and a positive electrode material layer disposed on at least one surface of the positive current collector. In this application, the positive electrode material layer may be disposed on one surface of the positive current collector in a thickness direction or on both surfaces of the positive current collector in the thickness direction. It is hereby noted that the “surface” here may be the entire region of the surface of the positive current collector, or a partial region of the surface of the positive current collector, without being particularly limited herein, as long as the objectives of the application can be achieved.

The positive current collector is not particularly limited herein, as long as the objectives of this application can be achieved. For example, the positive current collector may include aluminum foil, aluminum alloy foil, a composite current collector (such as an aluminum carbon composite current collector), or the like. The thickness of the positive current collector is not particularly limited in this application, as long as the objectives of this application can be achieved. For example, the thickness of the positive current collector is 5 μm to 20 μm. In this application, the positive electrode material layer includes a positive active material. The type of the positive active material is not particularly limited herein as long as the objectives of this application can be achieved. The positive active material includes a compound in which lithium ions can be reversibly intercalated and deintercalated. In some embodiments, the positive active material may include at least one of lithium nickel cobalt manganese oxide (NCM), lithium nickel cobalt aluminum oxide, lithium iron phosphate, a lithium-rich manganese-based material, lithium cobalt oxide, lithium manganese oxide, lithium manganese iron phosphate, or the like. The lithium nickel cobalt manganese oxide includes, but is not limited to, at least one of LiNi_{0.8}Co_{0.1}Mn_{0.1}O₂(NCM811), LiNi_{0.6}Co_{0.2}Mn_{0.2}O₂ (NCM₆₂₂), LiNi_{0.5}Co_{0.2}Mn_{0.3}O₂(NCM523), LiNi_{1/3}Co_{1/3}Mn_{1/3}O₂ (NCM333), or LiNi_{0.9}Co_{0.05}Mn_{0.05}O₂(NCM₉₅₅). The positive active material may be doped. In some embodiments, the doping elements may include at least one of K, Na, Ca, Mg, B, Al, Co, Si, V, Ga, Sn, or Zr. The thickness of the positive electrode material layer is not particularly limited herein as long as the objectives of this application can be achieved. For example, the thickness of the positive electrode material layer on a single side is 30 μm to 120 μm. The positive electrode material layer of this application may further include a positive conductive agent and a positive electrode binder. The positive conductive agent and the positive electrode binder are not particularly limited herein, as long as the objectives of this application can be achieved. For example, the positive conductive agent may be the same as the above-mentioned negative conductive agent, and the positive electrode binder may be the same as the above-mentioned negative electrode binder.

The method for preparing the positive electrode plate is not particularly limited herein as long as the objectives of this application can be achieved. For example, the positive electrode plate may be prepared by the following method: mixing a positive active material, a positive conductive agent, and a positive electrode binder, adding N-methylpyrrolidone (NMP), and stirring well to obtain a positive electrode slurry in which the solid content is 65 wt % to 85 wt %. Applying the positive electrode slurry evenly onto one surface of the positive current collector, and oven-drying the slurry to obtain a positive electrode plate coated with a positive electrode material layer on a single side. Subsequently, the above coating steps are repeated on the other surface of the positive current collector, and the positive current collector is oven-dried to obtain a positive electrode plate coated with a positive electrode material layer on both sides. After completion of applying the slurry, a positive electrode plate is obtained by cold-pressing and cutting.

The secondary battery according to this application further includes an electrolyte solution. The electrolyte solution of this application may include a lithium salt and an organic solvent. The type of the lithium salt is not particularly limited herein as long as the objectives of this application can be achieved. For example, the lithium salt may include, but is not limited to, at least one of lithium hexafluorophosphate (LiPF₆), lithium tetrafluoroborate (LiBF₄), lithium difluorophosphate (LiPO₂F₂), lithium bis(trifluoromethanesulfonyl)imide (LiTFSI), lithium bis(fluorosulfonyl)imide (LiFSI), lithium bis(oxalato)borate (LiBOB), or lithium difluoro(oxalato)borate (LiDFOB). The type of the organic solvent is not particularly limited herein as long as the objectives of this application can be achieved. For example, the organic solvent may include, but is not limited to, at least one of a carbonate ester compound, a carboxylate ester compound, an ether compound, or another organic solvent. The carbonate compound may include, but is not limited to, at least one of a chain carbonate compound or a cyclic carbonate compound. The chain carbonate compound may include, but is not limited to, at least one of dimethyl carbonate, diethyl carbonate (DEC), dipropyl carbonate, methyl propyl carbonate, ethylene propyl carbonate, or ethyl methyl carbonate. The cyclic carbonate ester compound may include, but is not limited to, at least one of ethylene carbonate (EC), propylene carbonate (PC), butylene carbonate, or vinyl ethylene carbonate. The carboxylate compound may include, but is not limited to, at least one of methyl formate, methyl acetate, ethyl acetate, n-propyl acetate, tert-butyl acetate, methyl propionate, ethyl propionate (EP), propyl propionate, γ-butyrolactone, decanolactone, valerolactone, or caprolactone. The ether compound may include, but is not limited to, at least one of ethylene glycol dimethyl ether, dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvent may include, but is not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The secondary battery of this application further includes a separator. The separator is not particularly limited herein as long as the objectives of this application can be achieved. For example, the separator may be made of a material including, but not limited to, at least one of polyethylene (PE)-based, polypropylene (PP)-based, or polytetrafluoroethylene-based polyolefin (PO) separator, a polyester film (such as polyethylene terephthalate (PET) film), a cellulose film, a polyimide film (PI), a polyamide film (PA), or a spandex or aramid film. The type of the separator may include, but is not limited to, a woven film, a non-woven film (non-woven fabric), a microporous film, a composite film, a calendered film, a spun film, or the like. The separator of this application may assume a porous structure. The porous layer is disposed on at least one surface of the separator. The porous layer includes inorganic particles and a binder. The inorganic particles may include at least one of aluminum oxide, silicon oxide, magnesium oxide, titanium oxide, hafnium dioxide, tin oxide, ceria, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder may include at least one of polyvinylidene fluoride, poly(vinylidene fluoride-co-hexafluoropropylene), a polyamide, polyacrylonitrile, polyacrylic ester, polyacrylic acid, sodium polyacrylate, sodium carboxymethyl cellulose, polyvinylpyrrolidone, polyvinyl ether, polymethyl methacrylate, polytetrafluoroethylene, or polyhexafluoropropylene. The pore size of the porous structure is not particularly limited as long as the objectives of this application can be achieved. For example, the pore size may be 0.01 μm to 1 μm. The thickness of the separator is not particularly limited herein as long as the objectives of this application can be achieved. For example, the thickness of the separator may be 4 μm to 12 μm.

The secondary battery of this application further includes a housing. The housing is configured to accommodate a positive electrode plate, a separator, a negative electrode plate, an electrolyte solution, and other components known in the art for use in the secondary battery. The other components are not limited herein. The housing is not particularly limited herein, and may be a housing well-known in the art, as long as the objectives of this application can be achieved. For example, the housing may be a hard housing or a flexible housing. The material of the hard housing may be metal. The type of the metal is not limited herein. The hard housing may be a metallic hard housing known in the art as long as the objectives of this application can be achieved. The flexible housing may be a metallic plastic film such as an aluminum plastic film, a steel plastic film.

The type of the secondary battery is not particularly limited herein, and may be any device in which an electrochemical reaction occurs. For example, the types of the secondary battery may include, but are not limited to, a lithium metal secondary battery, a lithium-ion battery, a sodium-ion battery, a lithium polymer secondary battery, and a lithium-ion polymer secondary battery. The shape of the secondary battery is not particularly limited herein as long as the objectives of this application can be achieved.

The process of preparing the secondary battery is well known to a person skilled in the art, and is not particularly limited herein. For example, the preparation process may include, but is not limited to, the following steps: stacking a positive electrode plate, a separator, a negative electrode plate, and a separator in sequence, and performing operations such as winding and folding as required to obtain a jelly-roll electrode assembly; putting the electrode assembly into a packaging bag, injecting an electrolyte solution into the packaging bag, and sealing the packaging bag to obtain a secondary battery; or, stacking a positive electrode plate, a separator, a negative electrode plate, and a separator in sequence, and then fixing the four corners of the entire stacked structure by use of adhesive tape to obtain a stacked-type electrode assembly, putting the electrode assembly into a packaging bag, injecting an electrolyte solution into the packaging bag, and sealing the packaging bag to obtain a secondary battery. In addition, an overcurrent prevention element, a guide plate, and the like may be placed into a pocket as required, so as to prevent the rise of internal pressure, overcharge, and overdischarge of the secondary battery.

A fourth aspect of this application provides an electronic device. The electronic device includes the secondary battery according to the third aspect of this application. The secondary battery provided in this application is of high safety and reliability, and therefore, the electronic device of this application achieves a relatively long service life.

The type of the electronic device is not particularly limited herein, and may be any electronic device known in the prior art. In some embodiments, the types of the electronic device may include, but are not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, or the like.

### EMBODIMENTS

The implementations of this application are described below in more detail with reference to embodiments and comparative embodiments. Various tests and evaluations are performed by the following methods. In addition, unless otherwise specified, the word “parts” means parts by mass, and the symbol “%” means a percentage by mass.

### Test Methods and Devices

### Sampling Method of the Negative Current Collector

A fully discharged lithium-ion battery is taken (in the discharging process, the battery is discharged at a current of 0.2C until the voltage reaches 3.0 V). The battery is disassembled, and a negative electrode plate is taken out. The negative electrode plate is soaked in dimethyl carbonate (DMC) for 20 minutes, and then rinsed with DMC and acetone successively. Subsequently, the negative electrode plate is put in an oven and baked at 80° C. for 12 hours to obtain a dried negative electrode plate. A negative electrode material layer is scraped off the surface of the negative electrode plate, the negative current collector is washed with deionized water, and then the negative current collector is baked at 80° C. for 12 hours to obtain a negative current collector sample.

In all the following tests on the porosity, tensile strength, thickness of the substrate layer, the thickness of the conductive coating, the resistance of the negative current collector, and the like, the negative current collector may be obtained by using the above sampling method.

### Testing the Porosity

A conductive coating is scraped off the surface of the negative current collector to obtain a substrate layer sample. First, the substrate layer sample is weighed to obtain a mass denoted as mg, and then measure the length, width, and height of the sample, respectively, and then the volume of the substrate layer sample is calculated as V cm³. The theoretical density of the substrate layer material is ρg/cm³. The porosity y of the substrate layer is calculated as Y=[1−m/(V×ρ)]×100%. The theoretical density of polypropylene is 0.90 g/cm³. The theoretical density of polyethylene is 0.93 g/cm³. The theoretical density of PET is 1.37 g/cm³.

### Testing the Tensile Strength of the Substrate Layer

The tensile strength of the substrate layer is measured by using a GoTech tensile machine. A conductive coating is scraped off the surface of the negative current collector to obtain a substrate layer sample. The substrate layer sample is die-cut by using a 20 mm×100 mm die. 10 specimen strips are cut out in each group. Both ends of each specimen strip are wrapped with one layer of crepe tape (to make it convenient to be clamped by a jig) to obtain a to-be-tested specimen. The tensile speed of the GoTech tensile machine is set to 50 mm/min, and the initial jig spacing is 40 mm. The to-be-tested specimen strip is placed between the grippers of the jig, with the upper and lower ends of the specimen strip clamped firmly by the jig. Subsequently, the GoTech tensile machine is started to start the tensile test until the sample snaps off. A tensile curve is recorded. Three specimen strips are measured in each group. The measured values of the specimen strips are averaged out to obtain the tensile strength of the substrate layer.

### Testing the Thickness of the Substrate Layer and the Thickness of the Conductive Coating

The thickness of the negative current collector is measured with a 0.1 μm resolution micrometer, denoted as H₁ μm, and then the conductive coating is scraped off the surface of the substrate layer and the thickness of the substrate layer is measured, denoted as H₂ μm. Therefore, the thickness of the conductive coating is H₃=H₁−H₂, in μm.

### Measuring the Resistance of the Negative Current Collector

The resistance of the negative current collector is measured by using a resistance meter (from Initial Energy Science & Technology Co. Ltd.). The negative current collector of each embodiment or comparative embodiment is cut into a rectangular sample of 20 mm in with and 60 mm in length. A separator of 25 mm in width and 70 mm in length is stacked with the negative current collector sample. The separator plays an insulating role. Subsequently, the stacked structure is folded in half along the midpoint of the 60 mm long side (that is, at 30 mm away from both ends of the long side) so that the two wide sides of the rectangle overlap. A test probe is placed on the upper and lower surfaces separately along the thickness direction at a corner near the wide side. The distance from the probes to the two adjacent edges of the negative current collector is 2 mm. Finally, the resistance of the sample is obtained by testing. 3 samples are measured separately in each group. The measured values are averaged out to obtain the resistance of the negative current collector.

### Testing the Safety and Reliability

The safety and reliability of the lithium-ion battery are evaluated by an impact pass rate. The higher the impact pass rate, the better the safety and reliability of the lithium-ion battery. In a 25° C. environment, the lithium-ion battery prepared in each embodiment or comparative embodiment is charged at a constant current of 0.2C until the voltage reaches 4.45 V, and then charged at a constant voltage of 4.45 V until the current drops to 0.025C, indicating a full charge state. The fully charged lithium-ion battery is placed on a test bench. A round rod with a diameter of φ15.8 mm and a length of 15.8 cm is placed at the center of the surface of the lithium-ion battery, the surface being parallel to the bench. The longitudinal axis of the round rod is perpendicular to the test bench. A 9.6 kg heavy hammer is dropped vertically and freely from a height of 610 mm from the test bench onto the upper end of the round rod. The bottom end of the round rod collides with the lithium-ion battery. Finally, the surface temperature of the lithium-ion battery is measured. Criteria of pass: The battery passes the test if no fire or heat generation occurs. 100 lithium-ion batteries prepared in each embodiment or comparative embodiment are tested.

Impact test pass rate=(number of lithium-ion batteries passing the test/100)×100%.

### Testing the C-Rate Performance

The C-rate performance of the lithium-ion battery is evaluated by the 0.5C discharge capacity retention rate. The higher the 0.5C discharge capacity retention rate, the higher the C-rate performance of the lithium-ion battery. In a 25° C. environment, the lithium-ion battery prepared in each embodiment or comparative embodiment is charged at a constant current of 0.2C until the voltage reaches 4.45 V, and then charged at a constant voltage of 4.45 V until the current drops to 0.025C, indicating a full charge state, and then discharged at a current of 0.2C until the voltage reaches 3.0 V. The above charging and discharging process is repeated 3 times, and the average of the three measured values of the discharge capacity is calculated as the 0.2C discharge capacity. Subsequently, the lithium-ion battery is charged at a constant current of 0.2C until the voltage reaches 4.45 V, and then charged at a constant voltage of 4.45 V until the current drops to 0.025C, indicating a full charge state, and then discharged at a current of 0.5C until the voltage reaches 3.0 V. The above charging and discharging process is repeated 3 times, and the average of the three measured values of the discharge capacity is calculated as the 0.5C discharge capacity.

0.5C discharge capacity retention rate=(0.5C discharge capacity/0.2C discharge capacity)×100%.

### Embodiment 1

### Preparing a Negative Current Collector

Polypropylene (PP, purchased from BASF, Germany) with a thickness of 10 μm, a weight-average molecular weight Mw=400,000, a porosity of 30%, and a tensile strength of 130 MPa is used as the substrate layer. Conductive carbon black (SP) as a conductive agent and polymethyl acrylate (Mw=20,000) as a binder are mixed at a mass ratio of 60:40. Deionized water is added into the mixture and stirred well to obtain a conductive coating slurry in which the solid content is 25 wt %. The conductive coating slurry is applied evenly on one surface of the substrate layer and dried at 85° C. for 4 hours to obtain a negative current collector coated with a conductive coating on a single side. The above steps are repeated on the other surface of the substrate layer to obtain a negative current collector coated with a conductive coating on both sides. Subsequently, the coated negative current collector is dried for 4 hours in an 85° C. vacuum environment, and then cold-pressed and slit to obtain a negative current collector.

### Preparing a Negative Electrode Plate

Graphite as a negative active material, carboxymethyl cellulose as a negative electrode thickener, and styrene-butadiene rubber as a negative electrode binder are mixed at a mass ratio of 98:1:1, and then deionized water is added and stirred well to obtain a negative electrode slurry in which the solid content is 54 wt %. The negative electrode slurry is applied evenly on one surface of the negative current collector, and dried at 85° C. for 4 hours to obtain a negative electrode plate coated with a negative electrode material layer on a single side. The above steps are repeated on the other surface of the negative current collector to obtain a negative electrode plate coated with the negative electrode material layer on both sides. Subsequently, the negative electrode plate is dried for 4 hours in an 85° C. vacuum environment, and then cold-pressed, cut, and slit to obtain a negative electrode plate of 78 mm×875 mm in size. Finally, the negative electrode plate and a negative tab (copper tab) are assembled together by a riveting technique. The negative tab runs through the negative electrode plate along the thickness direction of the negative electrode plate. The thickness of the negative tab is 80 μm. The compaction density of the negative electrode material layer is 1.75 g/cm³, and the thickness of the negative electrode material layer on a single side is 70 μm.

### Preparing a Positive Electrode Plate

LiCoO₂ as a positive active material, conductive carbon black as a positive conductive agent, polyvinylidene difluoride as a positive electrode binder are mixed at a mass ratio of 95.2:2.2:2.6, and N-methyl-pyrrolidone is added and stirred well to obtain a positive electrode slurry in which the solid content is 72 wt %. The positive electrode slurry is applied evenly on one surface of 10 μm-thick positive current collector aluminum foil, and the aluminum foil is dried at 85° C. for 4 hours to obtain a positive electrode plate coated with a positive electrode material layer on a single side. The above steps are repeated on the other surface of the aluminum foil to obtain a positive electrode plate coated with the positive electrode material layer on both sides. Subsequently, the positive electrode plate is dried for 4 hours in an 85° C. vacuum environment, and cold-pressed, cut, and slit to obtain a positive electrode plate of 74 mm×867 mm in size. Finally, an aluminum tab is welded as a positive tab onto the positive electrode plate. The compaction density of the positive electrode material layer is 4.15 g/cm³, and the thickness of the positive electrode material layer on a single side is 60 μm.

### Separator

PVDF and alumina ceramics are mixed at a mass ratio of 1:2, and NMP is added as a solvent to form a ceramics layer slurry in which the solid content is 12 wt %. The slurry is stirred well, and then the slurry is applied evenly onto one surface of a 5 μm-thick polyethylene (PE) substrate, and dried to obtain a separator coated with a 2 μm-thick alumina ceramics layer on a single side. PVDF is added to the NMP solvent and stirred evenly to form a PVDF slurry in which the solid content is 25 wt %. Subsequently, the PVDF slurry is applied at a concentration of 2.5 mg/1540.25 mm² onto the surface of the alumina ceramic layer, and dried at 85° C. for 4 hours to obtain a separator coated with an alumina ceramic layer and a PVDF adhesive layer on a single side. Finally, the above steps are repeated on the other surface of the polyethylene substrate to obtain a separator coated with the alumina ceramic layer and the PVDF adhesive layer on both sides.

### Preparing an Electrolyte Solution

Ethylene carbonate (EC), propylene carbonate (PC), diethyl carbonate (DEC), and ethyl propionate (EP) are mixed at a mass ratio of EC:PC:DEC:EP=3:1:3:3 in a dry argon atmosphere glovebox to form an organic solvent, and then a lithium salt hexafluorophosphate (LiPF₆) is added into the organic solvent to dissolve. The mixture is mixed evenly to obtain an electrolyte solution in which the concentration of the lithium salt is 1 mol/L.

### Preparing a Lithium-Ion Battery

The prepared positive electrode plate, separator, negative electrode plate, and separator are stacked in sequence in such a way that the separator is located between the positive electrode plate and the negative electrode plate to serve a function of separation, and then the stacked structure is wound to obtain an electrode assembly. The electrode assembly is put into an aluminum plastic film packaging bag, and then dehydrated in an 85° C. vacuum oven for 12 hours. The above-prepared electrolyte solution is injected into the packaging bag. The steps such as vacuum sealing, standing, chemical formation (the battery is charged at a constant current of 0.02C until the voltage reaches 3.5 V, and then charged at a constant current of 0.1C until the voltage reaches 3.9 V), shaping, capacity grading, and secondary packaging are performed to obtain a lithium-ion battery.

### Embodiments 2 to 39

Identical to Embodiment 1 except that the parameters are adjusted according to Table 1. In Embodiments 9 to 12, the PP materials of different porosities are purchased. The porosity of the substrate layer can be changed by changing the content of the pore-forming agent. The weight-average molecular weight of the PP is adjusted to keep the tensile strength of the material unchanged.

### Comparative Embodiment 1

Identical to Embodiment 1 except that the substrate layer is 10 μm-thick copper foil.

### Comparative Embodiment 2

Identical to Embodiment 1 except that the negative current collector is 12 μm-thick copper foil uncoated with a conductive coating on the surface.

### Comparative Embodiment 3

Identical to Embodiment 1 except that the conductive coating is replaced by a 1 μm-thick copper metal layer evaporation-deposited on the surface of the substrate layer.

### Comparative Embodiments 4 to 6

Identical to Embodiment 1 except that the parameters are adjusted according to Table 1. The PP materials of different porosities are purchased. The porosity of the substrate layer can be changed by changing the content of the pore-forming agent. The weight-average molecular weight of the PP is adjusted to keep the tensile strength of the material unchanged.

Table 1 shows the relevant parameters and performance test results in each embodiment and comparative embodiment.

TABLE 1

| | | | | | | Mass | | Resistance | | 0.5 C |
|---|---|---|---|---|---|---|---|---|---|---|
| | | Porosity | Tensile | Thickness | | percentage | Thickness | of | Impact | discharge |
| | Material | of | strength of | of | | of | of | negative | test | capacity |
| | of | substrate | substrate | substrate | | conductive | conductive | current | pass | retention |
| | substrate | layer | layer | layer | Conductive | agent | coating | collector | rate | rate |
| | layer | (%) | (MPa) | (μm) | agent | (%) | (μm) | (Ω) | (%) | (%) |
| Embodiment 1 | PP | 30 | 130 | 10 | SP | 60 | 1 | 823 | 83 | 71 |
| Embodiment 2 | PE | 30 | 130 | 10 | SP | 60 | 1 | 900 | 82 | 70 |
| Embodiment 3 | PET | 30 | 130 | 10 | SP | 60 | 1 | 1003 | 79 | 65 |
| Embodiment 4 | Cellulose | 30 | 130 | 10 | SP | 60 | 1 | 1022 | 81 | 64 |
| Embodiment 5 | PI | 30 | 130 | 10 | SP | 60 | 1 | 799 | 78 | 70 |
| Embodiment 6 | Polyamide | 30 | 130 | 10 | SP | 60 | 1 | 980 | 80 | 72 |
| Embodiment 7 | Spandex | 30 | 130 | 10 | SP | 60 | 1 | 1212 | 82 | 60 |
| Embodiment 8 | Aramid | 30 | 130 | 10 | SP | 60 | 1 | 1118 | 78 | 62 |
| Embodiment 9 | PP | 10 | 130 | 10 | SP | 60 | 1 | 879 | 81 | 69 |
| Embodiment 10 | PP | 20 | 130 | 10 | SP | 60 | 1 | 856 | 81 | 70 |
| Embodiment 11 | PP | 40 | 130 | 10 | SP | 60 | 1 | 788 | 83 | 72 |
| Embodiment 12 | PP | 50 | 130 | 10 | SP | 60 | 1 | 766 | 82 | 72 |
| Embodiment 13 | PP | 40 | 150 | 10 | SP | 60 | 1 | 788 | 84 | 71 |
| Embodiment 14 | PP | 40 | 180 | 10 | SP | 60 | 1 | 781 | 85 | 72 |
| Embodiment 15 | PP | 40 | 200 | 10 | SP | 60 | 1 | 756 | 86 | 72 |
| Embodiment 16 | PP | 40 | 200 | 5 | SP | 60 | 1 | 766 | 81 | 72 |
| Embodiment 17 | PP | 40 | 200 | 15 | SP | 60 | 1 | 998 | 85 | 69 |
| Embodiment 18 | PP | 40 | 200 | 20 | SP | 60 | 1 | 1088 | 86 | 66 |
| Embodiment 19 | PP | 40 | 200 | 10 | Conductive | 95 | 1 | 200 | 81 | 85 |
| | | | | | graphite | | | | | |
| Embodiment 20 | PP | 40 | 200 | 10 | SP | 95 | 1 | 189 | 82 | 86 |
| Embodiment 21 | PP | 40 | 200 | 10 | CNT | 95 | 1 | 50 | 83 | 98 |
| Embodiment 22 | PP | 40 | 200 | 10 | VCF | 95 | 1 | 70 | 83 | 94 |
| Embodiment 23 | PP | 40 | 200 | 10 | Graphene | 95 | 1 | 80 | 83 | 94 |
| Embodiment 24 | PP | 40 | 200 | 10 | CNT | 5 | 1 | 110 | 84 | 92 |
| Embodiment 25 | PP | 40 | 200 | 10 | CNT | 10 | 1 | 65 | 81 | 94 |
| Embodiment 26 | PP | 40 | 200 | 10 | CNT | 30 | 1 | 59 | 85 | 94 |
| Embodiment 27 | PP | 40 | 200 | 10 | CNT | 40 | 1 | 56 | 86 | 95 |
| Embodiment 28 | PP | 40 | 200 | 10 | CNT | 50 | 1 | 53 | 86 | 95 |
| Embodiment 29 | PP | 40 | 200 | 10 | CNT | 60 | 1 | 53 | 85 | 96 |
| Embodiment 30 | PP | 40 | 200 | 10 | CNT | 70 | 1 | 52 | 84 | 97 |
| Embodiment 31 | PP | 40 | 200 | 10 | CNT | 80 | 1 | 51 | 84 | 97 |
| Embodiment 32 | PP | 40 | 200 | 10 | CNT | 90 | 1 | 50 | 83 | 98 |
| Embodiment 33 | PP | 40 | 200 | 10 | CNT + SP | 40 + 10 | 1 | 55 | 86 | 93 |
| Embodiment 34 | PP | 40 | 200 | 10 | CNT + VCF | 40 + 10 | 1 | 62 | 81 | 92 |
| Embodiment 35 | PP | 40 | 200 | 10 | CNT + conductive | 40 + 10 | 1 | 64 | 84 | 93 |
| | | | | | graphite | | | | | |
| Embodiment 36 | PP | 40 | 200 | 10 | CNT | 50 | 0.2 | 256 | 86 | 85 |
| Embodiment 37 | PP | 40 | 200 | 10 | CNT | 50 | 0.5 | 133 | 84 | 91 |
| Embodiment 38 | PP | 40 | 200 | 10 | CNT | 50 | 2 | 27 | 85 | 98 |
| Embodiment 39 | PP | 40 | 200 | 10 | CNT | 50 | 5 | 10 | 84 | 98 |
| Comparative | Cu | 0 | 400 | 10 | SP | 60 | 1 | 0.6 | 30 | 98 |
| Embodiment 1 | | | | | | | | | | |
| Comparative | Cu | 0 | 400 | 12 | / | / | / | 0.3 | 35 | 51 |
| Embodiment 2 | | | | | | | | | | |
| Comparative | PP | 30 | 130 | 10 | / | / | 1 | 25 | 32 | 85 |
| Embodiment 3 | | | | | | | | | | |
| Comparative | PP | 0 | 130 | 10 | SP | 60 | 1 | 891 | 79 | 60 |
| Embodiment 4 | | | | | | | | | | |
| Comparative | PP | 60 | 80 | 10 | SP | 60 | 1 | 750 | / | / |
| Embodiment 5 | | | | | | | | | | |
| Comparative | PP | 30 | 80 | 10 | SP | 60 | 1 | 825 | / | / |
| Embodiment 6 | | | | | | | | | | |

Note:
“/” in Table 1 indicates absence of the corresponding substance or parameter.
When the conductive agent is CNT + SP, the mass percentage “40 + 10” of the conductive agent means that the mass percentage of the CNT is 40% and the mass percentage of the SP is 10%. Other similar expressions are understood by analogy.

As can be seen from Embodiments 1 to 39 and Comparative Embodiments 1 to 6, the negative current collector includes a substrate layer and a conductive coating, and the porosity and tensile strength of the substrate layer are controlled within the ranges specified herein. In this way, the resistance of the negative current collector is relatively low, the impact test pass rate and the 0.5C discharge capacity retention rate of the lithium-ion battery are relatively high, indicating that the lithium-ion battery exhibits good safety, reliability, and C-rate performance. In Comparative Embodiment 1, the negative current collector is copper foil without using the substrate layer material falling within the range specified herein. As a result, although the lithium-ion battery exhibits a relatively high 0.5C discharge capacity retention rate, the impact test pass rate is excessively low. In Comparative Embodiment 2, the negative current collector is copper foil and no conductive coating is provided. As a result, the impact test pass rate and the 0.5C discharge capacity retention rate of the lithium-ion battery are relatively low. In Comparative Embodiment 3, the composition of the conductive coating falls outside the range specified herein. As a result, the impact test pass rate of the lithium-ion battery is relatively low. In Comparative Embodiment 4, the 0.5C discharge capacity retention rate of the lithium-ion battery is relatively low. In the lithium-ion battery in Comparative Embodiment 5, the material of the substrate layer is of a relatively high porosity but excessively low tensile strength. In the lithium-ion battery in Comparative Embodiment 6, the tensile strength of the substrate layer is excessively low. The lithium-ion batteries prepared in Comparative Embodiments 5 and 6 are severely deformed after chemical formation, and the battery performance data fail to be obtained through testing.

The material of the substrate layer typically affects the safety, reliability, and C-rate performance of the lithium-ion battery. As can be seen from Embodiments 1 to 8, the substrate layer material falling within the range specified herein enables the lithium-ion battery to achieve a relatively high impact test pass rate and 0.5C discharge capacity retention rate, indicating that the lithium-ion battery exhibits good safety, reliability, and C-rate performance.

The porosity of the substrate layer typically affects the safety, reliability, and C-rate performance of the lithium-ion battery. As can be seen from Embodiment 1, Embodiments 9 to 12, and Comparative Embodiments 4 and 5, when the porosity of the substrate layer is excessively low, for example, in Comparative Embodiment 4, the impact test pass rate and the 0.5C discharge capacity retention rate of the lithium-ion battery are relatively low. When the porosity of the substrate layer is excessively high, for example, in Comparative Embodiment 5, the lithium-ion battery is severely deformed after chemical formation, and the battery performance data fail to be obtained through testing. Therefore, controlling the porosity of the substrate layer within the range specified herein enables the lithium-ion battery to achieve a relatively high impact test pass rate and 0.5C discharge capacity retention rate, indicating that the lithium-ion battery exhibits good safety, reliability, and C-rate performance.

The tensile strength of the substrate layer typically affects the safety, reliability, and C-rate performance of the lithium-ion battery. As can be seen from Embodiment 11, Embodiments 13 to 15, and Comparative Embodiment 6, when the tensile strength of the substrate layer is excessively low, for example, in Comparative Embodiment 6, the lithium-ion battery is severely deformed after chemical formation, and the battery performance data fail to be obtained through testing. When the tensile strength of the substrate layer is excessively high, the requirement on the substrate layer is excessively high, and the material is excessively costly. Therefore, controlling the tensile strength of the substrate layer within the range specified herein can reduce the cost of the lithium-ion battery and enable the lithium-ion battery to achieve a relatively high impact test pass rate and 0.5C discharge capacity retention rate, indicating that the lithium-ion battery is cost-effective and exhibits good safety, reliability, and C-rate performance.

The thickness of the substrate layer typically affects the safety, reliability, and C-rate performance of the lithium-ion battery. As can be seen from Embodiment 1 and Embodiments 16 to 18, controlling the thickness of the substrate layer within the range specified herein enables the lithium-ion battery to achieve a relatively high impact test pass rate and 0.5C discharge capacity retention rate, indicating that the lithium-ion battery exhibits good safety, reliability, and C-rate performance.

The composition of the conductive coating typically affects the safety, reliability, and C-rate performance of the lithium-ion battery. As can be seen from Embodiments 19 to 35, controlling the composition of the conductive agent coating within the range specified herein enables the lithium-ion battery to achieve a relatively high impact test pass rate and 0.5C discharge capacity retention rate, indicating that the lithium-ion battery exhibits good safety, reliability, and C-rate performance.

The thickness of the conductive coating typically affects the safety, reliability, and C-rate performance of the lithium-ion battery. As can be seen from Embodiment 28 and Embodiments 36 to 39, controlling the thickness of the conductive coating within the range specified herein enables the lithium-ion battery to achieve a relatively high impact test pass rate and 0.5C discharge capacity retention rate, indicating that the lithium-ion battery exhibits good safety, reliability, and C-rate performance. In Embodiment 39, with further increase of the thickness of the conductive coating, the impact test pass rate and 0.5C discharge capacity retention rate of the lithium-ion battery stop being further improved, and the energy density even decreases due to the increase of the thickness of the conductive coating. Therefore, when the thickness of the conductive coating falls within the range of 0.2 μm to 2 μm, the lithium-ion battery is enabled to exhibit higher overall performance.

It is hereby noted that the relational terms herein such as “first” and “second” are used merely to differentiate one entity or operation from another, but do not involve or imply any actual relationship or sequence between the entities or operations. Moreover, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. A negative electrode plate, comprising a negative current collector, the negative current collector comprises a substrate layer and a conductive coating disposed on a surface of the substrate layer, wherein the conductive coating comprises a conductive agent and a binder;
a material of the substrate layer comprises at least one selected from the group consisting of polypropylene, polyethylene, polyethylene terephthalate, cellulose, polyimide, polyamide, spandex, and aramid; and
a porosity of the substrate layer is 10% to 50%, and tensile strength of the substrate layer is 130 MPa to 200 MPa.

2. The negative electrode plate according to claim 1, wherein a thickness of the substrate layer is 5 μm to 20 μm.

3. The negative electrode plate according to claim 1, wherein a porosity of the substrate layer is 30% to 50%.

4. The negative electrode plate according to claim 1, wherein the tensile strength of the substrate layer is 150 MPa to 200 MPa.

5. The negative electrode plate according to claim 1, wherein the conductive agent comprises at least one selected from the group consisting of conductive graphite, conductive carbon black, carbon nanotubes, graphene, and carbon fibers; and
based on a mass of the conductive coating, a mass percentage of the conductive agent is 5% to 95%.

6. The negative electrode plate according to claim 5, wherein, based on the mass of the conductive coating, a mass percentage of the conductive agent is 30% to 50%.

7. The negative electrode plate according to claim 1, wherein a thickness of the conductive coating is 0.2 μm to 5 μm.

8. The negative electrode plate according to claim 1, wherein a thickness of the conductive coating is 0.5 μm to 2 μm.

9. The negative electrode plate according to claim 2, wherein the tensile strength of the substrate layer is 150 MPa to 200 MPa.

10. The negative electrode plate according to claim 3, wherein the tensile strength of the substrate layer is 150 MPa to 200 MPa.

11. A secondary battery, comprising a negative tab and a negative electrode plate, wherein the negative tab runs through the negative electrode plate along a thickness direction of the negative electrode plate, and the negative tab is connected to the conductive coating to form an electrical connection; the negative electrode plate comprises a negative current collector, the negative current collector comprises a substrate layer and a conductive coating disposed on a surface of the substrate layer, wherein the conductive coating comprises a conductive agent and a binder;
a material of the substrate layer comprises at least one selected from the group consisting of polypropylene, polyethylene, polyethylene terephthalate, cellulose, polyimide, polyamide, spandex, and aramid; and
a porosity of the substrate layer is 10% to 50%, and tensile strength of the substrate layer is 130 MPa to 200 MPa.

12. The secondary battery according to claim 11, wherein a thickness of the substrate layer is 5 μm to 20 μm.

13. The secondary battery according to claim 11, wherein a porosity of the substrate layer is 30% to 50%.

14. The secondary battery according to claim 11, wherein the tensile strength of the substrate layer is 150 MPa to 200 MPa.

15. The secondary battery according to claim 11, wherein the conductive agent comprises at least one selected from the group consisting of conductive graphite, conductive carbon black, carbon nanotubes, graphene, and carbon fibers; and
based on a mass of the conductive coating, a mass percentage of the conductive agent is 5% to 95%.

16. The secondary battery according to claim 15, wherein, based on the mass of the conductive coating, a mass percentage of the conductive agent is 30% to 50%.

17. The secondary battery according to claim 11, wherein a thickness of the conductive coating is 0.2 μm to 5 μm.

18. The secondary battery according to claim 11, wherein a thickness of the conductive coating is 0.5 μm to 2 μm.

19. The secondary battery according to claim 12, wherein the tensile strength of the substrate layer is 150 MPa to 200 MPa.

20. An electronic device, comprising the secondary battery according to claim 11.
